(19) United States
(12) Patent Application Publication
(10) Pub. No.: US 2010/0315354 A1
(43) Pub. Date: Dec. 16, 2010

(54) ELECTRONIC DEVICE OF TOUCH INPUT TYPE

(75) Inventors: Dong-Sun Park, Seoul (KR); Yeon-Ho Son, Hwasung-si (KR); Jae-Kyung Kim, Ansan-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/616,495

(22) Filed: Nov. 11, 2009

(30) Foreign Application Priority Data
Jun. 16, 2009 (KR) 10-2009-0053418

(51) Int. Cl. G06F 3/041

(52) U.S. Cl. 345/173

(57) ABSTRACT

A touch input-type electronic device is disclosed. In accordance with an embodiment of the present invention, the touch input-type electronic device includes a touchscreen panel, a base coupled to the touchscreen panel, and an actuator, in which the other end of the actuator is coupled to the base such that vibration of one end of the actuator is transferred to the touchscreen panel. Thus, the touch input-type electronic device in accordance with an embodiment of the present invention can provide a more profound sensory feel by vibrating to a position at which the user directly touches.

### CROSS-REFERENCE TO RELATED APPLICATIONS

This application claims the benefit of Korean Patent Application No. 10-2009-0053418, filed with the Korean Intellectual Property Office on Jun. 16, 2009, the disclosure of which is incorporated herein by reference in its entirety.

### BACKGROUND

1. Technical Field

The present invention relates to a touch input-type electronic device.

2. Description of the Related Art

A touchscreen panel is a type of input device with which a user can press a particular area with a finger or a stylus pen to enter an input. The touchscreen panel can transfer an input signal corresponding to the pressed position to the electronic device in which the touchscreen panel is installed.

To provide a better appealing sensory feel in the electronic devices, such as mobile phones, etc., a growing number of electronic devices are now capable of providing feedback in the form of vibration in response to the touching on a touchscreen by a user.

Such devices have required a larger capacity of driver in order to provide a greater feedback to the user by having the entire electronic device vibrate when the touchscreen panel is touched by the user.

However, there is a limit to increasing the size of a portable electronic device and increasing the capacity of the battery, curbing an improved sensory feel to the user.

### SUMMARY

The present invention provides a touch input-type electronic device that can provide a more profound sensory feel.

An aspect of the present invention provides a touch input-type electronic device that includes a touchscreen panel, a base coupled to the touchscreen panel, and an actuator, in which the other end of the actuator is coupled to the base such that vibration of one end of the actuator is transferred to the touchscreen panel.

The actuator can include a supporting member, in which the other end of the supporting member is coupled to the base, and a piezoelectric component, which is coupled to the supporting member. The piezoelectric component can be a stacked piezoelectric component.

The actuator can be a plurality of actuators, and the plurality of actuators can be disposed symmetrically on either side of the base. More specifically, the plurality of actuators can be disposed along a perimeter of the base.

The base can include a housing hole formed at a position adjacent to one end of the actuator so as not to obstruct a movement of one end of the actuator.

The touchscreen panel can be coupled to one surface of the base, and the touch input-type electronic device can further include a vibration-absorbing material coupled to the other surface of the base.

The touch input-type electronic device can further include a display panel interposed between the base and the touchscreen panel.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view of a touch input-type electronic device in accordance with an embodiment of the present invention.

FIG. 2 is a perspective view of a touch input-type electronic device in accordance with an embodiment of the present invention.

FIG. 3 is a perspective view illustrating one surface of a base of a touch input-type electronic device in accordance with an embodiment of the present invention.

FIG. 4 is a perspective view illustrating the other surface of a base of a touch input-type electronic device in accordance with an embodiment of the present invention.

FIG. 5 is an enlarged side view of part A of FIG. 4.

FIG. 6 is a perspective view of a touchscreen panel of a touch input-type electronic device in accordance with an embodiment of the present invention.

FIG. 7 is a perspective view illustrating one surface of a frame of a touch input-type electronic device in accordance with an embodiment of the present invention.

FIG. 8 is a perspective view illustrating the other surface of a frame of a touch input-type electronic device in accordance with an embodiment of the present invention.

FIG. 9 is a perspective view illustrating an example of a modified base of a touch input-type electronic device in accordance with an embodiment of the present invention.

### DETAILED DESCRIPTION

The features and advantages of this invention will become apparent through the below drawings and description.

A touch input-type electronic device according to a certain embodiment of the present invention will be described below in more detail with reference to the accompanying drawings. Those components that are the same or are in correspondence are rendered the same reference numeral regardless of the figure number, and redundant descriptions are omitted.

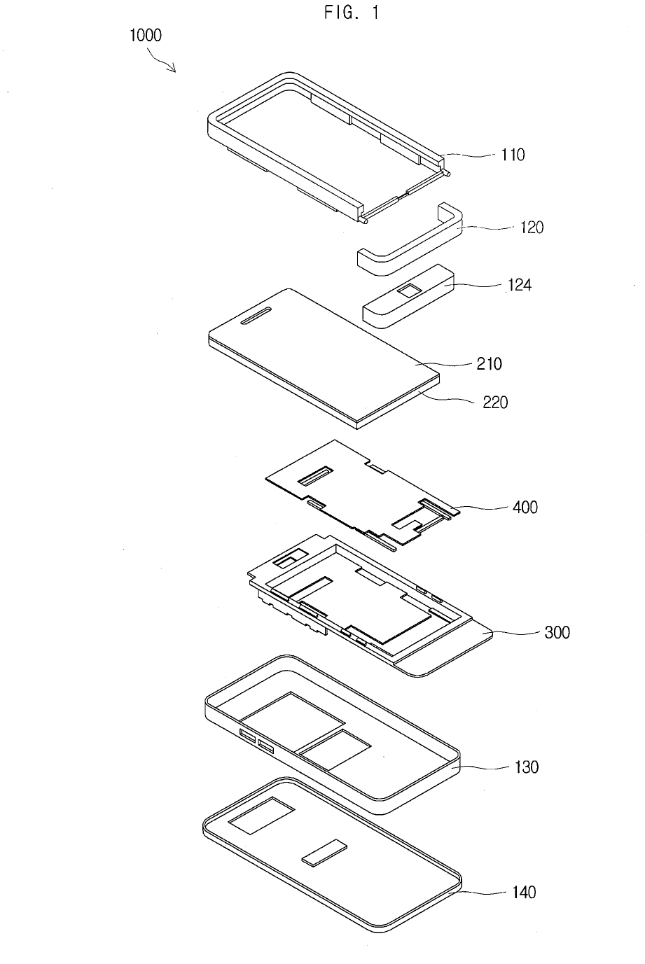

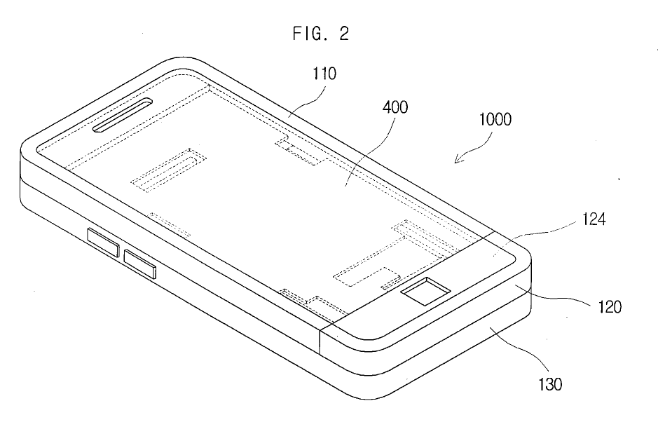

FIG. 1 is an exploded perspective view of a touch input-type electronic device 1000 according to an embodiment of the present invention, and FIG. 2 is a perspective view of a touch input-type electronic device 1000 according to an embodiment of the present invention.

As shown in FIGS. 1 and 2, the touch input-type electronic device 1000 according to an embodiment of the present invention can include a touchscreen panel 210, a base 400, which is coupled to the touchscreen panel 210, and an actuator (not shown), of which the other end is coupled to the base 400 so as to deliver the vibration of one end of the actuator to the touchscreen panel 210. Thus, the touch input-type electronic device 1000 in accordance with an embodiment of the present invention can provide a more profound sensory feel by vibrating to a position at which the user directly touches.

The touch input-type electronic device 1000 refers to a device that can be inputted with information by a user's touch using a touchscreen panel 210 as an input unit. The touch input-type electronic device 1000 can be implemented as, for example, a mobile phone, PDA (personal digital assistant), PMP (portable multimedia player), GPS navigation system, information kiosk, game console, and vending machine.

The touch input-type electronic device 1000 can also include a display panel 220. The display panel 220 is coupled to a lower surface of the touchscreen panel 210. The display panel 220, which is an image output unit of the touch input-type electronic device 1000, can display an image outputted by the touch input-type electronic device 1000.

The touch input-type electronic device 1000 can include a controller (not shown) that controls the operation of the components constituting the touch input-type electronic device 1000. When the user touches a particular area on the touchscreen panel 210, the touchscreen panel 210 transmits a touch signal to the controller. The controller then provides an operating signal to an actuator, which provides vibration to the touchscreen panel 210 that the user touches. The actuator can operate depending on whether or not the user has touched the touchscreen panel 210.

A case refers to a frame in which the components constituting the touch input-type electronic device 1000 can be embedded. In accordance with an embodiment of the present invention, the case includes an upper case 110 and a lower case 130. The upper case 110 covers an upper side of the touch input-type electronic device 1000, while the lower case 130 covers a lower side of the touch input-type electronic device 1000.

The touchscreen panel 210 and the display panel 220 are coupled to each other, and can be supported by a frame 300. Each of them has a rectangular shape. The frame 300 supports the internal components of the touch input-type electronic device 1000 from the inside. The frame 300 can support a base 400, which will be described later, the touchscreen panel 210 and the display panel 220.

The upper case 110 covers the perimeter of the touchscreen panel 210, and its inner circumference supports the outer circumference of the touchscreen panel 210.

A keypad 124 is coupled to a lengthwise end of the touchscreen panel 210, and an input device, in which information can be inputted by the touch of the user, is coupled to the keypad 124. The keypad 124 is supported by the frame 300, and the perimeter of the keypad 124 is supported to the frame 300by a keypad cover 120.

The lower case 130 covers a lower side of the touch input-type electronic device 1000 and thus provides a space in which the components constituting the touch input-type electronic device 1000 can be housed. A lower side of the lower case 130 is covered by a battery cover 140.

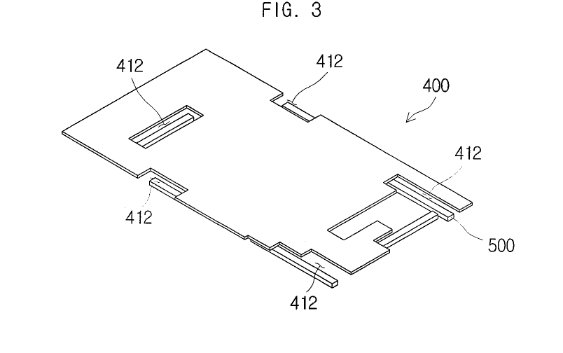

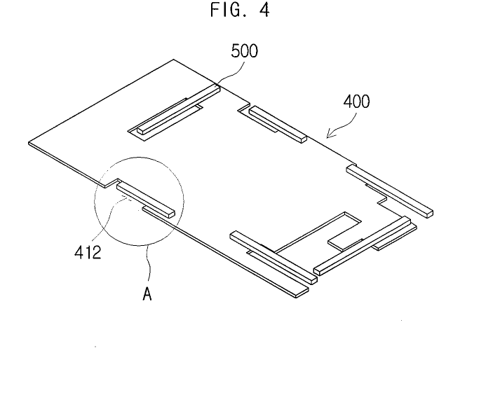

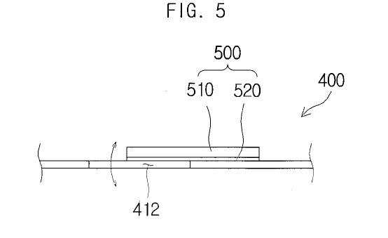

FIG. 3 is a perspective view illustrating one surface of the base 400 of the touch input-type electronic device 1000 according to an embodiment of the present invention, and FIG. 4 is a perspective view illustrating the other surface of the base 400 of the touch input-type electronic device 1000 according to an embodiment of the present invention. FIG. 5 is an enlarged side view of part A of FIG. 4.

As shown in FIGS. 3 to 5, a total of six actuators 500 are symmetrically coupled to the base 400 along the perimeter of the base 400. The actuators 500 are shaped to extend lengthwise, and each of the actuators 500 is disposed along the perimeter of the touchscreen panel 210.

One end of each actuator 500 is not fixed to the base 400, like a free end of a vibrating body, and thus can be vibrated freely and vertically by the vibration of the actuator. The other end of each actuator 500 is fixed to the base 400, like a fixed end of a vibrating body.

A housing hole 412 is formed in a portion of the base 400 at which one end of an actuator 500 is disposed, so as to provide a space where the one end of the actuator 500 can be vibrated freely. The housing hole 412 can be formed in the shape of a groove formed in the base 400, or can be formed in the shape of an opening penetrating through the base 400.

One end of a supporting member 520, i.e., a portion of the supporting member 520, is disposed in the housing hole 412, while the other end of the supporting member 520, i.e., the remaining portions of the supporting member 520, is fixed to the base 400. The supporting member 520 can be deformed with the deformation of a piezoelectric component 510. By having the supporting member 520 coupled with the piezoelectric component 510 already before being fixed to the base 400, the process of assembling the actuator 500 can be improved.

This arrangement can also prevent the piezoelectric component 510 from being cracked by an external shock, which may be applied to the touch input-type electric device 1000 while using the touch input-type electronic device 1000, thus improving the shock resistance of the piezoelectric component 510.

The supporting member 520 is shaped to extend lengthwise according to the shape of the actuator 500, and the piezoelectric component 510 is coupled on top of the supporting member 520. The piezoelectric component 510 can be polarized in a vertical direction, and can be a stacked piezoelectric component constituted by a plurality of layers.

Therefore, when voltage is supplied to the actuator 500, the actuator 500 vibrates vertically. In this way, one end of the actuator 500 can vibrate freely and vertically in the housing hole 412, while the other end of the actuator 500 is fixed to the base 400. With this arrangement, the actuator 500 becomes a kind of a cantilever, and thus the vibration of one end of the actuator 500 can be maximized through the other end of the actuator 500 and transferred to the base 400.

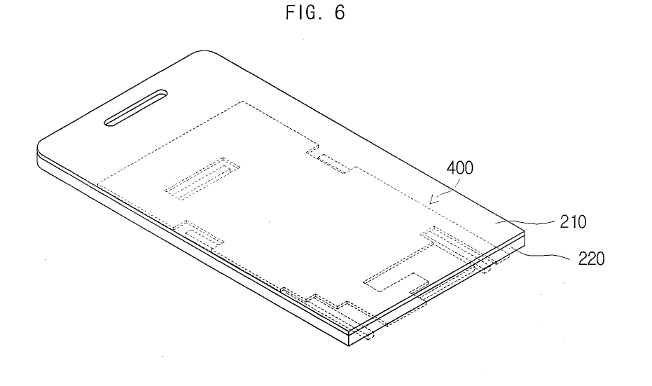

FIG. 6 is a perspective view of the touchscreen panel 210 of the touch input-type electronic device 1000 according to an embodiment of the present invention. As shown in FIG. 6, the base 400 is coupled to the entire lower surface of the display panel 220. Thus, the vibration generated by the actuator 500 can be transferred to the entire surface of the touchscreen panel 210 by way of the base 400.

The user can be provided with a feedback, corresponding to the user's touch, throughout the entire touchscreen panel 210, and thus a more profound sensory feel can be provided to the user. Furthermore, the vibration generated by the actuator is transferred more efficiently to the touchscreen panel 210 so that a more profound sensory feel can be provided although a smaller capacity actuator 500 is used.

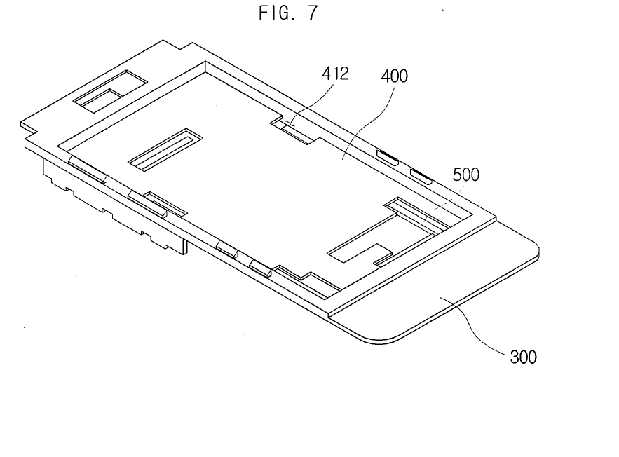

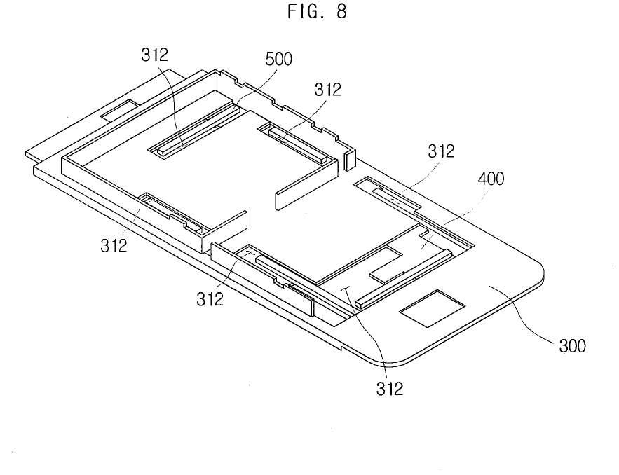

FIG. 7 is a perspective view illustrating one surface of the frame 300 of the touch input-type electronic device 1000 according to an embodiment of the present invention, and FIG. 8 is a perspective view illustrating the other surface of the frame 300 of the touch input-type electronic device 1000 according to an embodiment of the present invention.

As shown in FIGS. 7 and 8, the base 400 is supported by the frame 300. In the frame 300, a housing hole 312 is formed at a position corresponding to one end of the actuator 500 so as not to obstruct the vibration of one end of the actuator 500. Here, the position of the housing hole 312, which is formed in the frame 300, can be the same as the position of the housing hole 412, which is formed in the base 400.

It is also possible that the housing hole 312 formed in the frame 300 can be positioned to correspond to the position of the actuator 500 and made bigger than the actuator 500 so that one entire actuator 500 can be accommodated in the housing hole 312 in order to provide a thinner touch input-type electronic device 1000.

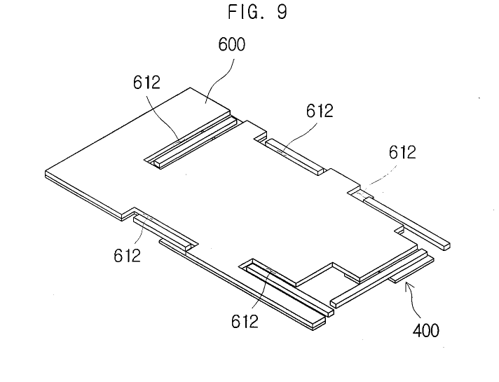

FIG. 9 is a perspective view illustrating a modified base 400 of the touch input-type electronic device 1000 according to an embodiment of the present invention. As in the example shown in FIG. 9, a vibration-absorbing material 600 made of, for example, rubber, can be coupled to the back surface of the base 400 opposite to the surface coupled to the display panel 220. That is, the vibration-absorbing material 600 is positioned between the base 400 and the frame 300.

It is evident that the vibration-absorbing material 600 has a housing hole 612 formed therein at a position corresponding to the position of the actuator 500, the housing hole 612 being big enough to accommodate the actuator 500.

Therefore, the vibration generated by the actuator 500 can be transferred to the touchscreen panel 210 only, and no vibration is transferred to the side of the frame 300, which does not need the vibration, thereby efficiently transferring the vibration of the actuator 500 to the user.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

What is claimed is:

1. A touch input-type electronic device comprising:
a touchscreen panel;
a base coupled to the touchscreen panel; and
an actuator, the other end of the actuator being coupled to the base such that vibration of one end of the actuator is transferred to the touchscreen panel.

2. The touch input-type electronic device of claim 1, wherein the actuator comprises:
a supporting member, the other end of the supporting member being coupled to the base; and
a piezoelectric component coupled to the supporting member.

3. The touch input-type electronic device of claim 2, wherein the piezoelectric component is a stacked piezoelectric component.

4. The touch input-type electronic device of claim 1, wherein the actuator is a plurality of actuators.

5. The touch input-type electronic device of claim 4, wherein the plurality of actuators are disposed symmetrically on either side of the base.

6. The touch input-type electronic device of claim 5, wherein the plurality of actuators are disposed along a perimeter of the base.

7. The touch input-type electronic device of claim 1, wherein the base comprises a housing hole formed at a position adjacent to one end of the actuator so as not to obstruct a movement of one end of the actuator.

8. The touch input-type electronic device of claim 1, wherein the touchscreen panel is coupled to one surface of the base, and wherein the touch input-type electronic device further comprises a vibration-absorbing material coupled to the other surface of the base.

9. The touch input-type electronic device of claim 1, further comprising a display panel interposed between the base and the touchscreen panel.
